(19) United States
(12) Patent Application Publication
(10) Pub. No.: US 2024/0417554 A1
(43) Pub. Date: Dec. 19, 2024

(54) POLYPROPYLENE COMPOSITION

(71) Applicant: Basell Poliolefine Italia S.r.l., Milano (IT)

(72) Inventors: Eleonora Ciaccia, Ferrara (IT); Marco Ciarafoni, Ferrara (IT); Caroline Cathelin, Ferrara (IT); Alberta De Capua, Ferrara (IT); Giansiro Prini, Ferrara (IT); Daniele Po, Ferrara (IT); Tiziana Caputo, Ferrara (IT); Roberto Pantaleoni, Ferrara (IT); Alessia Di Capua, Ferrara (IT)

(73) Assignee: Basell Poliolefine Italia S.r.l., Milano (IT)

(21) Appl. No.: 18/698,632

(22) PCT Filed: Oct. 6, 2021
(86) PCT No.: PCT/EP2021/077491

§ 371 Date: Apr. 4, 2024

(51) Int. Cl. C08L 23/12

(52) U.S. Cl. CPC C08L 23/12; C08L 2205/025; C08L 2205/03

(57) ABSTRACT

A polypropylene composition made from or containing:
A) from 71 wt % to 91 wt % of a propylene homopolymer,
B) from 5 wt % to 15 wt % of a copolymer of propylene and ethylene containing from 18 wt % to 32.0 wt % of ethylene derived units; and
C) from 4 wt % to 15 wt % of a copolymer of propylene and ethylene containing from 75 wt % to 90.0 wt % of ethylene derived units.

### FIELD OF THE INVENTION

In general, the present disclosure relates to the field of chemistry. More specifically, the present disclosure relates to polymer chemistry. In particular, the present disclosure relates to polypropylene composition.

### BACKGROUND OF THE INVENTION

Isotactic polypropylene is used in a variety of applications. In some instances, the properties one or more copolymerization steps or one or more monomers have been introduced into the propylene stereoregular homopolymerization process.

### SUMMARY OF THE INVENTION

In a general embodiment, the present disclosure provides a polypropylene composition made from or containing:

A) from 71 wt % to 91 wt % of a propylene homopolymer having:
a fraction soluble in xylene at 25° C. between 1.5 wt % and 4.0 wt %, based upon the total weight of the propylene homopolymer; and
a melt flow rate (MFR L according to ISO 1133, condition L, that is, 230° C. and 2.16 kg load) from 60.0 to 110.0 g/10 min;

B) from 5 wt % to 15 wt % of a copolymer of propylene and ethylene containing from 18 wt % to 32.0 wt % of ethylene derived units, based upon the total weight of the copolymer of propylene and ethylene (B);

wherein
the xylene soluble fractions at 25° C. of A)+B) ranges from 7 wt % to 15 wt %, based upon the combined weight of fractions A)+B);
the intrinsic viscosity of the xylene soluble fractions at 25° C. of A)+B) ranges from 0.5 dl/g to 0.5 to 1.5 dl/g; and
the content of ethylene derived units in the fraction soluble in xylene at 25° C. of A)+B) ranges from 12.3 wt % to 24 wt %, based upon the combined weight of fractions A)+B), and being lower than the content of ethylene derived units of component B); and

C) from 4 wt % to 15 wt % of a copolymer of propylene and ethylene containing from 75 wt % to 90.0 wt % of ethylene derived units, based upon the total weight of the copolymer of propylene and ethylene (C);

wherein the polypropylene composition has
a xylene soluble fraction at 25° C. ranging from 5.0 wt % to 14.0 wt %, based upon the total weight of the polypropylene composition;
a content of ethylene derived units in the fraction soluble in xylene at 25° C. ranging from 26.0 wt % to 43.0 wt %, based upon the total weight of the polypropylene composition;
an intrinsic viscosity of the xylene soluble fractions at 25° C. ranging from 0.5 dl/g to 0.5 to 1.5 dl/g;
at least two melting points, the higher ranging from 156.0° C. to 166.0° C. and the lower ranging from 100.0° C. to 135.0° C.; and
a melt flow rate (MFR L according to ISO 1133, condition L, that is, 230° C. and 2.16 kg load) ranging from 35.0 to 95.0 g/10 min,
   the amount of components A), B), and C) being 100 wt %.

### DETAILED DESCRIPTION OF THE INVENTION

In some embodiments, the present disclosure provides a polypropylene composition made from or containing:

A) from 71 wt % to 91 wt %; alternatively from 75 wt % to 86 wt %; alternatively from 78 wt % to 83 wt %, of a propylene homopolymer having:
a fraction soluble in xylene at 25° C. between 1.5 wt % and 4.0 wt %; alternatively from 1.8 wt % to 3.8 wt %; alternatively from 2.0 wt % to 3.2 wt %, based upon the total weight of the propylene homopolymer; and
a melt flow rate (MFR L according to ISO 1133, condition L, that is, 230° C. and 2.16 kg load) ranging from 60.0 to 110.0 g/10 min; alternatively from 71 g/10 min to 99 g/10 min; alternatively from 75 g/10 min to 89 g/10 min;

B) from 5 wt % to 15 wt %, alternatively from 7 wt % to 13 wt %; alternatively from 8 wt % to 12 wt %, of a copolymer of propylene and ethylene containing from 18.0 wt % to 32.0 wt %, alternatively from 20.0 wt % to 30.0 wt %; alternatively from 22.0 wt % to 28.0 wt %, of ethylene derived units, based upon the total weight of the copolymer of propylene and ethylene (B);

wherein
the xylene soluble fractions at 25° C. of A)+B) ranging from 7 wt % to 15 wt %; alternatively from 8 wt % to 13 wt %; alternatively from 9 wt % to 12 wt %, based upon the combined weight of fractions A)+B);
the intrinsic viscosity of the xylene soluble fractions at 25° C. of A)+B) ranges from 0.5 to 1.5 dl/g; alternatively from 0.7 to 1.3 dl/g; alternatively form 0.8 to 1.2 dl/g; and
the content of ethylene derived units in the fraction soluble in xylene at 25° C. of A)+B) ranges from 12.3 wt % to 24.0 wt %; alternatively from 14.2 wt % to 22.5 wt %, alternatively from 15.8 wt % to 21.4 wt %, based upon the combined weight of fractions A)+B), and being lower than the content of ethylene derived units of component B); and

C) from 4 wt % to 15 wt %, alternatively from 6 wt % to 13 wt %; alternatively from 8 wt % to 11 wt %, of a copolymer of propylene and ethylene containing from 75.0 wt % to 90.0 wt %; alternatively from 78.0 wt % to 88.0 wt %; alternatively from 79.0 wt % to 85.0 wt %, of ethylene derived units, based upon the total weight of the copolymer of propylene and ethylene (C);

wherein the polypropylene composition has
a xylene soluble fraction at 25° C. ranging from 5.0 wt % to 14.0 wt %, alternatively from 7.0 wt % to 13 wt %; alternatively from 8.0 wt % to 12.0 wt %, based upon the total weight of the polypropylene composition;
a content of ethylene derived units in the fraction soluble in xylene at 25° C. ranging from 26.0 wt % to 43.0 wt %; alternatively from 28.0 wt % to 40.0 wt %; alternatively from 29.5 wt % to 36.2 wt %, based upon the total weight of the polypropylene composition;
an intrinsic viscosity of the fraction soluble in xylene at 25° C. ranging from 0.5 dl/g to 1.5 dl/g; alternatively from 0.7 dl/g to 1.3 dl/g; alternatively from 0.8 dl/g to 1.2 dl/g;
at least two melting points, the higher ranging from 156.0° C. to 166.0° C.; alternatively ranging from 158.0° C. to 165.0° C., alternatively from 160.0° C. and 164.0° C., and the lower ranging from 100.0° C. to 135.0° C., alternatively from 111.0° C. to 130.0° C.; alternatively from 115° C. and 127° C.; and
a melt flow rate (MFR L according to ISO 1133, condition L, that is, 230° C. and 2.16 kg load) ranging from 35.0 to 95.0 g/10 min; alternatively from 40.0 to 70.0 g/10 min; alternatively from 45.0 to 65.0 g/10 min,
   the amount of components A), B), and C) being 100 wt %.

As used herein, the term “copolymer” refers to a polymer containing two kinds of monomers, propylene and ethylene, in the absence of other monomers.

In some embodiments, the polypropylene composition is used in molding articles. In some embodiments, the molded articles are injection molding articles, alternatively thin-walled injection molded (TWIM) articles.

In some embodiments, the polypropylene composition has the relation: (tensile modulus×charpy at 0° C.)/haze is higher than 100, alternatively higher than 125; alternatively higher than 135.

In some embodiments, the polypropylene composition has a tensile modulus ranging from 1100 MPa to 2000 MPa, alternatively from 1200 MPa to 1800 MPa.

In some embodiments, the polypropylene composition is produced by sequential polymerization in at least three stages, with each subsequent polymerization stage being conducted in the presence of the polymeric material formed in the immediately preceding polymerization reaction. In some embodiments, the component (A) is prepared in at least one first polymerization stage. In some embodiments, the component (B) is prepared in at least one second polymerization stage. In some embodiments, the component C) is prepared in at least one third polymerization stage.

In some embodiments, the polymerization process is carried out in gas phase or in liquid phase, in continuous or batch reactors, such as fluidized bed or slurry reactors. In some embodiments, the polymerization of the propylene polymer (A) is carried out in liquid phase, using liquid propylene as diluent, while the copolymerization stage to obtain the propylene copolymer fractions (B) and C) are carried out in gas phase, without intermediate stages except for the partial degassing of the monomers. In some embodiments, the sequential polymerization stages are carried out in gas phase. In some embodiments, the temperature for the preparation of fractions (A), (B), and (C) are the same or different and from 50° C. to 120° C. In some embodiments, the polymerization pressure ranges from 0.5 to 12 MPa and the polymerization is carried out in gas-phase. In some embodiments, the catalytic system is pre-contacted (pre-polymerized) with small amounts of olefins. In some embodiments, the molecular weight of the propylene polymer composition is regulated. In some embodiments, the molecular weight regulator is hydrogen.

In some embodiments and in the second and third stage of the polymerization process, the propylene/ethylene copolymers (B) and (C) are produced in a fluidized-bed gas-phase reactor in the presence of the polymeric material and the catalyst system coming from the preceding polymerization step. In some embodiments, the propylene polymer compositions are obtained by separately preparing the components (A), (B), and (C), and subsequently mechanically blending the components in the molten state. In some embodiments, the mechanical blending is achieved with twin-screw extruders.

In some embodiments, each polymerization stage is carried out in presence of a highly stereospecific heterogeneous Ziegler-Natta catalyst. In some embodiments, the Ziegler-Natta catalysts are made from or containing a solid catalyst component made from or containing a titanium compound having a titanium-halogen bond and an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. W000163261.

In some embodiments, the polypropylene composition is obtainable by polymerizing propylene and ethylene in various stages in the presence of a catalyst system made from or containing the product obtained by contacting the following components:
a) a solid catalyst component made from or containing a magnesium halide, a titanium compound having a Ti-halogen bond and an electron donor compound selected from succinates,
b) an aluminum hydrocarbyl compound, and
c) optionally an external electron donor compound.

In some embodiments and in the solid catalyst component (a), the succinate is selected from succinates of formula (I)

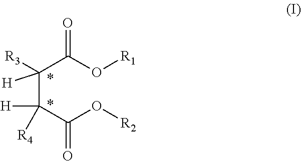

wherein the radicals R₁ and R₂, equal to or different from each other are a C₁-C₂₀ linear or branched alkyl, alkenyl, cycloalkyl, aryl, arylalkyl, or alkylaryl group, optionally containing heteroatoms; and the radicals R₃ and R₄, equal to or different from each other, are C₁-C₂₀ alkyl, C₃-C₂₀ cycloalkyl, C₅-C₂₀ aryl, arylalkyl, or alkylaryl group, providing that R₃, R₄, or both are a branched alkyl. In some embodiments, the compounds are, with respect to the two asymmetric carbon atoms identified in the structure of formula (I), stereoisomers of the type (S,R) or (R,S).

In some embodiments, R₁ and R₂ are selected from the group consisting of C₁-C₈ alkyl, cycloalkyl, aryl, arylalkyl, and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, R₃, R₄, or both radicals are secondary alkyls or cycloalkyls. In some embodiments, the secondary alkyls are selected from the group consisting of isopropyl, sec-butyl, 2-pentyl, and 3-pentyl. In some embodiments, the cycloalkyls are selected from the group consisting of cyclohexyl, cyclopentyl, and cyclohexylmethyl.

In some embodiments, the compounds are the (S,R) (S,R) forms pure or in mixture, optionally in racemic form, of compounds selected from the group consisting of diethyl 2,3-bis(trimethylsilyl) succinate, diethyl 2,3-bis(2-ethylbutyl) succinate, diethyl 2,3-dibenzylsuccinate, diethyl 2,3-diisopropylsuccinate, diisobutyl 2,3-diisopropylsuccinate, diethyl 2,3-bis(cyclohexylmethyl) succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the catalyst component (a) is made from or containing internal electron donors, a titanium compound having a Ti-halogen bond, and a Mg halide. In some embodiments, the magnesium halide is MgCl₂ in active form.

In some embodiments, the titanium compounds are selected from the group consisting of TiCl₄ and TiCl₃. In some embodiments, the titanium compounds are Ti-haloalcoholates of formula Ti(OR)_{n-y}X_{y}, where n is the valence of titanium, y is a number between 1 and n−1, X is halogen, and R is a hydrocarbon radical having from 1 to 10 carbon atoms.

In some embodiments, the catalyst component (a) has an average particle size ranging from 15 to 80 μm, alternatively from 20 to 70 μm, alternatively from 25 to 65 μm.

In some embodiments, the aluminum hydrocarbyl compound (b) is a trialkyl aluminum compound. In some embodiments, the trialkyl aluminum compound is selected from the group consisting of triethylaluminum, tri-n-hexylaluminum, and tri-n-octylaluminum. In some embodiments, mixtures of trialkylaluminums with alkylaluminum halides, alkylaluminum hydrides, or alkylaluminum sesquichlorides, are used. In some embodiments, alkylaluminum sesquichlorides are selected from the group consisting of AlEt₂Cl and Al₂Et₃Cl₃.

In some embodiments, external electron-donor compounds are selected from the group consisting of silicon compounds, ethers, esters, amines, heterocyclic compounds, ketones, and the 1,3-diethers. In some embodiments, the ester is ethyl 4-ethoxybenzoate. In some embodiments, the heterocyclic compound is 2,2,6,6-tetramethyl piperidine. In some embodiments, the silicon compounds have formula Rₐ⁵R_{b}⁶Si(OR⁷)_{c}, wherein a and b are integers from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-methyl-dimethoxysilane. In some embodiments, the amount of external electron donor compound provides a molar ratio between the aluminum hydrocarbyl compound and the electron donor compound of from 5 to 500, alternatively from 5 to 400, alternatively from 10 to 200.

In some embodiments, the catalyst forming components are contacted with a liquid inert hydrocarbon solvent, at a temperature below about 60° C., alternatively from about 0 to 30° C., for a time period of from about 6 seconds to 60 minutes. In some embodiments, the liquid inert hydrocarbon solvent is propane, n-hexane, or n-heptane.

In some embodiments, the catalyst components (a), (b), and optionally (c) are fed to a pre-contacting vessel, in amounts such that the weight ratio (b)/(a) is in the range of 0.1-10. In some embodiments compound (c) is present, and the weight ratio (b)/(c) is weight ratio of from 5 to 500, alternatively from 5 to 400, alternatively from 10 to 200. In some embodiments, the components are pre-contacted at a temperature of from 10 to 20° C., for 1-30 minutes. In some embodiments, the precontact vessel is a stirred tank reactor.

In some embodiments, the precontacted catalyst is then fed to a prepolymerization reactor where a prepolymerization step takes place. In some embodiments, the prepolymerization step is carried out in a first reactor selected from a loop reactor or a continuously stirred tank reactor. In some embodiments, the prepolymerization step is carried out in liquid-phase. In some embodiments, the liquid medium is made from or containing liquid alpha-olefin monomer(s), optionally with the addition of an inert hydrocarbon solvent. In some embodiments, the hydrocarbon solvent is either aromatic or aliphatic. In some embodiments, the aromatic solvent is toluene. In some embodiments, the aliphatic solvent is selected from the group consisting of propane, hexane, heptane, isobutane, cyclohexane, and 2,2,4-trimethylpentane. In some embodiments, the amount of hydrocarbon solvent is lower than 40% by weight with respect to the total amount of alpha-olefins, alternatively lower than 20% by weight. In some embodiments, the prepolymerization step is carried out in the absence of inert hydrocarbon solvents.

In some embodiments, the average residence time in this reactor ranges from 2 to 40 minutes, alternatively from 10 to 25 minutes. In some embodiments, the temperature ranges between 10° C. and 50° C., alternatively between 15° C. and 35° C. In some embodiments, the pre-polymerization degree is in the range from 60 to 800 g per gram of solid catalyst component, alternatively from 150 to 500 g per gram of solid catalyst component. In some embodiments, the concentration of solid in the slurry is in the range from 50 g to 300 g of solid per liter of slurry.

In some embodiments, the polypropylene composition is further made from or containing additives. In some embodiments, the additives are selected from the group consisting of antioxidants, light stabilizers, nucleating agents, antiacids, colorants, and fillers.

In some embodiments, the polypropylene composition is used for the production of injection molded articles.

The following examples are given to illustrate, and not to limit, the present disclosure.

### EXAMPLES

The data of the propylene polymer materials were obtained according to the following methods:

### Melt Flow Rate

Determined according to ISO 1133 (230° C., 2.16 kg).

### Determination of Ethylene (C2) Content by NMR

¹³C NMR spectra were acquired on a Bruker AV-600 spectrometer equipped with cryoprobe, operating at 160.91 MHz in the Fourier transform mode at 120° C. Ethylene was measured on the total composition. The ethylene content of component B) was calculated by using the amount of component B) according to the following equation:

$${C}_{2 tot} = {C}_{2 B} X wt \% compB / 100.$$

The peak of the Sββ carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethylaluminum chloride” M. Kakugo, Y. Naito, K. Mizunuma and T. Miyatake, Macromolecules, 1982, 15, 1150) using the following equations:

$$\begin{matrix}\begin{matrix}PPP = 100 T ββ / S & PPE = 100 T βδ / S & EPE = 100 T δδ / S \\ PEP = 100 S ββ / S & PEE = 100 S βδ / S & EEE = 100 ( 0.25 S γδ + 0.5 S δδ ) / S\end{matrix} \\ S = T ββ + T βδ + T δδ + S ββ + S βδ + 0.25 S γ δ + 0.5 S δδ\end{matrix}$$

The molar percentage of ethylene content was evaluated using the following equation:

$$E \% mol = 100 * [ PEP + PEE + EEE ]$$

The weight percentage of ethylene content was evaluated using the following equation:

$$100 * E \% mol * MWE \\ E \% wt . = E \% mol * MWE + P \% mol * MWP$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

### Molar Ratios of the Feed Gases

Determined by gas-chromatography.

### Samples for the Mechanical Analysis

Samples were obtained according to ISO 294-2.

### Flexural Modulus

Determined according to ISO 178.

### Melting Temperature, Melting Enthalpy and Crystallization Temperature

Determined according to ISO 11357-3, at scanning rate of 20 C/min both in cooling and heating, on a sample of weight between 5 and 7 mg under inert N2 flow. Instrument calibration was with Indium.

### Xylene Soluble and Insoluble Fractions at 25° C. (Room Temperature)

Xylene Solubles according to ISO 16 152; with solution volume of 250 ml, precipitation at 25° C. for 20 minutes, 10 minutes of which with the solution in agitation (magnetic stirrer), and with drying at 70° C. under vacuum.

### Intrinsic Viscosity (I.V.)

The sample was dissolved in tetrahydronaphthalene at 135° C. and then poured into the capillary viscometer.

The viscometer tube (Ubbelohde type) was surrounded by a cylindrical glass jacket. This setup allowed for temperature control with a circulating thermostatic liquid.

The downward passage of the meniscus was timed by a photoelectric device. The passage of the meniscus in front of the upper lamp started the counter, which had a quartz crystal oscillator. The counter stopped as the meniscus passed the lower lamp. The efflux time was registered and converted into a value of intrinsic viscosity.

### Charpy Impact Strength

Charpy impact test according to ISO 179-1eA, e ISO 1873-2.

### Haze (on 1 mm Plaque)

5×5 cm specimens were cut from molded plaques of 1 mm thick. The haze value was measured using a Gardner photometric unit connected to a Hazemeter type UX-10 or an equivalent instrument having G.E. 1209 light source with filter “C”. Standard samples were used for calibrating the instrument. The plaques to be tested were produced according to the following method.

75×75×1 mm plaques was molded with a GBF Plastiniector G235190 Injection Molding Machine, 90 tons under the following processing conditions:
Screw rotation speed: 120 rpm
Back pressure: 10 bar
Melt temperature: 260° C.
Injection time: 5 sec
Switch to hold pressure: 50 bar
First stage hold pressure: 30 bar
Second stage pressure: 20 bar
Hold pressure profile: First stage 5 sec
Second stage 10 sec
Cooling time: 20 sec
Mold water temperature: 40° C.

### Example 1

### Catalyst System

The Ziegler-Natta catalyst was prepared according to the Example 5, lines 48-55 of the European Patent No. EP728769. Triethylaluminium (TEAL) was used as co-catalyst, and dicyclopentyldimethoxysilane (DCPMS) was used as external donor, with the weight ratios indicated in Table 1.

### Prepolymerization Treatment

The solid catalyst component was subjected to prepolymerization by suspending the solid catalyst component in liquid propylene at 20° C. for about 5 minutes, before introducing the solid catalyst component into the first polymerization reactor.

### Polymerization

The polymerization run was conducted in continuous mode in a series of four reactors equipped with devices to transfer the product from each reactor to the subsequent reactor. The first and second reactors were liquid phase reactors. The third and fourth reactors were fluidized-bed, gas phase reactors. Component (A) was prepared in the first and second reactors. Component (B) was prepared in the third reactor. Component (C) was prepared in the fourth reactor.

Hydrogen was used as molecular weight regulator.

The gas phase (propylene, ethylene, and hydrogen) was continuously analyzed via gas-chromatography.

At the end of the run, the powder was discharged and dried under a nitrogen flow.

The main polymerization conditions are reported in Table1.

TABLE 1

| | | Ex. 1 | Comp ex 3 |
|---|---|---|---|
| TEAL/solid catalyst component | | 9.5 | 9.3 |
| weight ratio | | | |
| TEAL/DCPMS weight ratio | | 10 | 10 |
| Liquid phase reactors | | | |
| Polymerization temperature | ° C. | 70 | 70 |
| Pressure | Bar-g | 38 | 38 |
| Residence time | minutes | 49 | 46 |
| H2 feed | molppm | 5538 | 5839 |
| 1st gas phase reactor | | | |
| Polymerization temperature | ° C. | 75 | 70 |
| Pressure | Barg | 16 | 13 |
| Residence time | min | 31 | 58 |
| C2/(C2 + C3) | Mol ratio | 0.076 | 0.70 |
| H2/C2 | Mol ratio | 0.829 | 0.592 |
| 2nd gas phase reactor | | | |
| Polymerization temperature | ° C. | 80 | — |
| Pressure | Barg | 13 | — |
| Residence time | min | 43 | |
| C2/(C2 + C3) | Mol ratio | 0.702 | — |
| H2/C2 | Mol ratio | 0.597 | — |

C2 = ethylene;
C3 = propylene;
H2 = hydrogen

The polymers features are reported in Table 2.

TABLE 2

| Example | | Ex1 | Comp ex 2 | Comp 3x 3 |
|---|---|---|---|---|
| Component a) | | | | |
| Split | wt % | 81 | 85 | 85 |
| Ethylene content | wt % | 0 | 3.2 | 0 |
| MFR | g/10′ | 79 | 20 | 81 |
| Xylene soluble at 25° C. | wt % | 2.5 | 6 | 3.2 |
| Component b) | | | | |
| split | wt % | 10 | 15 | 15 |
| Ethylene content in | wt % | 25.0 | 80 | 82.0 |
| component B) | | | | |
| Xylene soluble at 25° C. | Wt % | 11.8 | — | — |
| (A) + B) | | | | |
| XSIV (intrinsic viscosity | dl/g | 1.0 | — | — |
| of XS) | | | | |
| Ethylene content on the | wt % | 19.0 | — | — |
| xylene soluble fraction | | | | |
| (A) + B)) | | | | |
| | | | — | — |
| Component C) | | | — | — |
| split | wt % | 9 | — | — |
| Ethylene content in | wt % | 82 | — | — |
| component C) | | | | |
| | | | — | |
| Property of the | | | — | — |
| composition | | | | |
| Xylene soluble at 25° C. | wt % | 13.7 | — | 13.7 |
| MFR | g/10′ | 53 | — | 64 |
| XSIV (intrinsic viscosity | dl/g | 1.03 | 1.2 | 1.05 |
| of XS) | | | | |
| Ethylene content on the | Wt % | 10 | — | 64.4 |
| xylene soluble fraction | | | | |
| Tensile Modulus | MPa | 1420 | 990 | 1950 |
| Haze (1 mm plaque) | % | 23 | 16.4 | 25 |
| Melting temperature | ° C. | 163.0-122.8 | — | 163.3-110.8 |
| Charpy impact 23° C. | KJ/m² | 4.4 | — | 2.1 |
| Charpy impact 0° C. | KJ/m² | 2.2 | — | 1.1 |

Comparative example 2 was prepared as described for example 1 of Patent Cooperation Treaty Publication No. WO 2011/045194, wherein the tensile modulus was reported.

1. A polypropylene composition comprising:
A) from 71 wt % to 91 wt % of a propylene homopolymer having:
a fraction soluble in xylene at 25° C. between 1.5 wt % and 4.0 wt %, based upon the total weight of the propylene homopolymer; and
a melt flow rate (MFR L according to ISO 1133, condition L, that is, 230° C. and 2.16 kg load) from 60.0 to 110.0 g/10 min;
B) from 5 wt % to 15 wt %, of a copolymer of propylene and ethylene containing from 18 wt % to 32.0 wt %, of ethylene derived units, based upon the total weight of the copolymer of propylene and ethylene (B);
wherein
the xylene soluble fractions at 25° C. of A)+B) ranges from 7 wt % to 15 wt %, based upon the combined weight of fractions A)+B);
the intrinsic viscosity of the xylene soluble fractions at 25° C. of A)+B) ranges from 0.5 dl/g to 1.5 dl/g; and
the content of ethylene derived units in the fraction soluble in xylene at 25° C. of A)+B) ranges from 12.3 wt % to 24 wt %, based upon the combined weight of fractions A)+B), and being lower than the content of ethylene derived units of component B);
C) from 4 wt % to 15 wt %, of a copolymer of propylene and ethylene containing from 75 wt % to 90.0 wt % of ethylene derived units, based upon the total weight of the copolymer of propylene and ethylene (C);
wherein the polypropylene composition has
a xylene soluble fraction at 25° C. ranging from 5.0 wt % to 14.0 wt %, based upon the total weight of the polypropylene composition;
a content of ethylene derived units in the fraction soluble in xylene at 25° C. ranging from 26.0 wt % to 43.0 wt %, based upon the total weight of the polypropylene composition;
an intrinsic viscosity of the xylene soluble fractions at 25° C. ranging from 0.5 to 1.5 dl/g;
at least two melting points, the higher ranging from 156.0° C. to 166.0° C. and the lower ranging from 100.0° C. to 135.0° C.; and
a melt flow rate (MFR L according to ISO 1133, condition L, that is, 230° C. and 2.16 kg load) ranging from 35.0 to 95.0 g/10 min,
the amount of components A), B) and C) being 100 wt %.

2. The polypropylene composition according to claim 1, wherein component (A) ranges from 75 wt % to 86 wt %, component B) ranges from 7 wt % to 13 wt %, and component C) ranges from 6 wt % to 13 wt %.

3. The polypropylene composition according to claim 1, wherein, in component A), the propylene homopolymer has a fraction soluble in xylene at 25° C. from 1.8 wt % to 3.8 wt %, based upon the total weight of the propylene homopolymer.

4. The polypropylene composition according to claim 1, wherein component B) contains from 20.0 wt % to 30.0 wt % of ethylene derived units, based upon the total weight of the copolymer of propylene and ethylene (B).

5. The polypropylene composition according to claim 1, wherein the xylene soluble fractions at 25° C. of A)+B) ranges from 8 wt % to 13 wt %, based upon the combined weight of fractions A)+B).

6. The polypropylene composition according to claim 1, wherein the content of ethylene derived units in the fraction soluble in xylene at 25° C. of A)+B) ranges from 14.2 wt % to 22.5 wt %, based upon the combined weight of fractions A)+B).

7. The polypropylene composition according to claim 1, wherein component C) contains from 78.0 wt % to 88.0 wt % of ethylene derived units, based upon the total weight of the copolymer of propylene and ethylene (C).

8. The polypropylene composition according to claim 1, wherein the polypropylene composition has the xylene soluble fraction at 25° C. ranging from 7.0 wt % to 13 wt %, based upon the total weight of the polypropylene composition.

9. The polypropylene composition according to claim 1, wherein the polypropylene composition has the content of ethylene derived units in the fraction soluble in xylene at 25° C. ranging from 28.0 wt % to 40.0 wt %, based upon the total weight of the polypropylene composition.

10. The polypropylene composition according to claim 1, wherein the polypropylene composition has the intrinsic viscosity of the fraction soluble in xylene at 25° C. ranging from 0.7 dl/g to 1.3 dl/g.

11. The polypropylene composition according to claim 1, wherein the polypropylene composition has at least two melting points, the higher ranging from 158.0° C. to 165.0° C. and the lower ranging from 111.0° C. to 130.0° C.

12. The polypropylene composition according to claim 1, wherein the melt flow rate (MFR L according to ISO 1133, condition L, that is, 230° C. and 2.16 kg load) ranges from 40.0 to 70.0 g/10 min.

13. The polypropylene composition according to claim 1, wherein the polypropylene composition has the content of ethylene derived units in the fraction soluble in xylene at 25° C. ranging from 29.5 wt % to 36.2 wt %, based upon the total weight of the polypropylene composition.

14. The polypropylene composition according to claim 1, wherein the polypropylene composition has the xylene soluble fraction at 25° C. ranging from 8.0 wt % to 12.0 wt %, based upon the total weight of the polypropylene composition.

15. An injection-molded article comprising the polypropylene composition of claim 1.
